(19) United States
(12) Patent Application Publication
(10) Pub. No.: US 2019/0092960 A1
(43) Pub. Date: Mar. 28, 2019

(54) SUBSTRATE WITH CELLULOSE ACETATE COATING

(71) Applicant: ACETATE INTERNATIONAL LLC, Irving, TX (US)

(72) Inventors: Michael COMBS, Pembroke, VA (US); Paul BUSBY, Blacksburg (GB); Melissa ALDRICH-WELCH, Rich Creek, VA (US)

(21) Appl. No.: 16/137,811

(22) Filed: Sep. 21, 2018

Related U.S. Application Data
(60) Provisional application No. 62/561,994, filed on Sep. 22, 2017.

(51) Int. Cl. C09D 101/12; C09D 5/00; B05D 1/02; B05D 1/28

(52) U.S. Cl. CPC C09D 101/12; B05D 1/28; B05D 1/02; C09D 5/00

(57) ABSTRACT

Disclosed are substrates coated with cellulose acetate and methods of forming the coated substrates. The coated substrate may be oil resistant and water resistant. The coated substrate may be used for food packaging.

### CROSS-REFERENCE TO RELATED APPLICATION

This application is a non-provisional of U.S. Provisional Application No. 62/561,994, filed on Sep. 22, 2017, the entire contents and disclosure of which are hereby incorporated by reference.

### FIELD OF THE INVENTION

The present invention relates generally to substrates coated with cellulose acetate that are environmentally friendly. In particular, the present invention relates to oil resistant, grease resistance, and/or water resistant cellulose acetate coated substrates for use in food related and non-food related applications.

### BACKGROUND OF THE INVENTION

Food packaging and food service items are often single use and may generate significant amounts of trash and pollution. For example, meat packaging trays are generally comprised of polystyrene. Although polystyrene may be recycled, it usually cannot be recycled for use in products that contact food due to health concerns. Thus, new (not recycled) polystyrene is typically used for products that contact food. Alternative products, such as plant fibers, cardboard, and other materials have been tried, but with unsatisfactory results.

Cellulose ester coatings, such as cellulose acetate, have been used in various consumer products, including liquid crystal displays and other electronic displays. Coatings of cellulose esters have also been used in pharmaceutical products. Cellulose ester coatings have potential for food packaging and food service items based on a desire to use environmentally friendly materials. This desire, however, must be balanced with using materials that are safe for use in food packaging and food service items, and that is durable enough for such use. Environmentally friendly materials may generally be classified as compostable or biodegradable. There is also a distinction between compostable and biodegradable materials. Compostable materials meet ASTM D6400 (2012), which requires the material to break down into carbon dioxide, water, inorganic compounds and biomass at a rate similar to paper, to disintegrate into small pieces in a certain period of time, and to leave no toxic residue. Biodegradable materials must be capable of disintegration by biological means within a specified time period.

By designing items to be compostable, the durability of the item may be reduced. For example, an item that degrades when exposed to water may not have sufficient water resistance when in use. To improve the performance of the item, various additives are often included.

For example, US Publication No. 2014/0186644 discloses a moisture barrier coating that is biodegradable and compostable. Some embodiments also relate to a coating that is dual ovenable. Such coatings may be used to increase moisture resistance and provide non-stick or release characteristics when applied to biodegradable and compostable disposable food packaging and food service items. In some embodiments, a plasticizer or an amide wax are added to a cellulose-ester, shellac, and rosin based coating to increase moisture resistance and reduce brittleness. In other embodiments, phospholipids or medium-chain triglycerides or increased levels of amide wax may be added to the either of the embodiments above to provide enhanced release characteristics. Such additives can introduce additional costs and complexities into the manufacturing process and can impact the ability of the material to degrade.

U.S. Pat. No. 3,141,778 discloses a coating composition for articles of food consisting essentially of from 40 to 50 parts of cellulose propionate, from 1 to 5 parts of propylene glycol and from 45 to 59 parts of a non-toxic plasticizer other than said glycol for said ester.

JP Publication No. 2004099151 discloses a composite container for packaging food which includes a container body made of a water-soluble or water-dissociation paper base, and has its internal surface coated with a protective film made of a biodegradable plastic film or a water-soluble film. The container enables the plastic film with the food residue attached to be composted together with paper and recycled into compost. Moreover, the plastic film with the food residue attached can be separated from the paper and composted together with other garbage for recycling. The paper can be restored into resources together with other paper.

Accordingly, the need exists for a simple yet effective and environmentally friendly cellulose acetate coating that may be used to coat substrates, including food packaging and food items.

### SUMMARY OF THE INVENTION

In some aspects, the present invention is directed to a coated substrate, comprising: (a) a substrate having a surface; and (b) a coating layer disposed on the surface, the coating layer comprising a cellulose acetate film having a glass transition temperature (Tg) of at least 140° C. The coating layer may have a thickness from 0.1 to 500 microns. The coating layer may be compostable. The substrate may be compostable. The coating layer and/or the substrate may be biodegradable. The substrate may comprise cardboard, paper, plastic, fabric, paperboard, or combinations thereof. The coating layer may be oil resistant and water resistant. The coating layer may have a pencil hardness from 6B to 3H according to ASTM D3363 (2011). In some aspects, the substrate is coated with the coating layer on at least a top and bottom surface. In other aspects, the substrate is coated on a top surface only or a bottom surface only. The coating layer may have heat stability up to at least 150° C. The coating layer may further comprise at least one of plasticizer, dyes, pigments, fragrance, repellants, indicators, surface agents, adhesion promoters, and gloss enhancers.

In another embodiment, the present invention is directed to a method of forming a coated substrate, the method comprising: a) combining cellulose acetate with a solvent to form a coating formulation; b) coating at least one surface of the substrate with the coating formulation; and c) affixing the coating formulation on the substrate to form a coated substrate. The coating formulation may have a solids concentration from 0.1 to 80%. The coating step may comprise coating the coating formulation on the substrate in a thickness from 0.1 to 500 microns. The coating formulation may have a viscosity from 25 to 10000 cps. The solvent may comprise acetone, ethyl acetate, methyl ethyl ketone, ethyl lactate, methyl amyl ketone, methyl propyl ketone and dimethyl carbonate, aprotic glycol ether, aprotic glycol ether ester, dimethyl sulfoxide (DMSO), n-methyl pyrrolidone (NMP), dimethylacetamide (DMAC), and combinations thereof. The coating formulation can be applied to the at least one surface of the substrate by, for example, spray coating. The coating can be applied to the at least one surface of the substrate by, for example, dip coating or brush coating. The coating layer may have heat stability up to at least 150° C. The coating layer may be oil and water resistant.

In yet another embodiment, the present invention is directed to a cellulose acetate coating formulation, the formulation comprising cellulose acetate and a solvent, wherein the formulation has a solids content from 0.1 to 80% and a viscosity from 50 to 10000 cps. The cellulose acetate may have a degree of substitution from 2.0 to 3.0, e.g., 2.1 to 2.9, 2 to 2.8, or 2.3 to 2.6.

### BRIEF DESCRIPTION OF THE DRAWINGS

The present invention will be better understood in view of the appended non-limiting figure, in which:

FIG. 1 shows a cross-sectional view of a coated substrate in accordance with embodiments of the present invention.

FIG. 2 shows a cross-sectional view of a substrate coated on both sides in accordance with embodiments of the present invention.

FIG. 3 shows a cross-sectional view of a substrate continuously coated in accordance with embodiments of the present invention.

FIG. 4 shows a cross-sectional view of a substrate continuously coated in accordance with embodiments of the present invention.

### DETAILED DESCRIPTION OF THE INVENTION

### I. Introduction

The present disclosure is directed to cellulose acetate coated substrates. The cellulose acetate coating may be disposed on at least one surface of the substrate. The cellulose acetate coating is a film comprising cellulose acetate having a glass transition temperature (Tg) of at least 140° C. The coated substrate may be formed by combining cellulose acetate with a solvent to form a coating formulation. At least one of surface of the substrate may then be coated with the coating formulation. The coating formulation is then fixed onto the substrate to form a coated substrate. The coating formulation may comprise cellulose acetate and a solvent. The formulation may have a solids content from 0.1 to 80% and a viscosity from 50 to 10,000 cps.

### II. Cellulose Acetate

As described herein, the present disclosure involves film coatings comprising cellulose acetate. Cellulose acetate, as used herein, refers to cellulose diacetate. In some aspects, the cellulose acetate has a degree of substitution from 2 to 2.6.

Cellulose acetate may be prepared by known processes, including those disclosed in U.S. Pat. No. 2,740,775 and in U.S. Publication No. 2013/0096297, the entireties of which are incorporated herein by reference. Typically, acetylated cellulose is prepared by reacting cellulose with an acetylating agent in the presence of a suitable acidic catalyst and then de-esterifying.

The cellulose may be sourced from a variety of materials, including cotton linters, a softwood or from a hardwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods. In some aspects, a hardwood cellulose is preferred for acetylating.

Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high degree of substitution (DS) value, such as from 2.5 to 3, e.g., about 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C₁ to C₂₀ alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 2.9, e.g., from 1.0 to 2.8, from 1.5 to 2.9, or from 2 to 2.6. The degree of substitution may be selected based on an organic solvent to be used with the cellulose acetate in the coating process. For example, when acetone is used as an organic solvent, the degree of substitution may range from 2.2 to 2.65.

The number average molecular weight of the cellulose acetate may range from 30,000 amu to 100,000 amu, e.g., from 50,000 amu to 80,000 amu and may have a polydispersity from 1.5 to 2.5, e.g., from 1.75 to 2.25 or from 1.8 to 2.2. All molecular weight recited herein, unless otherwise specified, are number average molecular weights. The molecular weight may be selected based on the desired hardness of the final wood filler composition. Although greater molecular weight leads to increased hardness, greater molecular weight also increases viscosity. The cellulose acetate may be provided in powder or flake form.

In some aspects, blends of different molecular weight cellulose acetate flake or powder may be used. Accordingly, a blend of high molecular weight cellulose acetate, e.g., a cellulose acetate having a molecular weight above 60,000 amu, may be blended with a low molecular weight cellulose acetate, e.g., a cellulose acetate having a molecular weight below 60,000 amu. The ratio of high molecular weight cellulose acetate to low molecular weight cellulose acetate may vary but may generally range from 1:10 to 10:1; e.g., from 1:5 to 5:1 or from 1:3 to 3:1.

### III. Cellulose Acetate Coating and Preparation Thereof

The cellulose acetate described herein may be prepared as a film. In some embodiments, the film can have a thickness from 0.1 micron to 500 micron, e.g., from 0.5 to 500 micron, from 1 micron to 400 micron, from 1 to 300 micron, from 1 to 250 micron, from 1 to 100 micron, from 10 to 100 micron, from 0.5 to 100 micron, from 0.5 to 10 micron. Pure cellulose acetate is difficult to process as a raw material because its decomposition temperature is lower than melt-processing temperatures. One optional solution to this problem is to use plasticizers. Combining a plasticizer with cellulose acetate reduces interactions between segments of the cellulose acetate polymer chain and reduces the glass transition temperature, melt viscosity and elastic modulus of the cellulose acetate, making the plasticized cellulose acetate melt processable.

Generally, the cellulose acetate film comprises from 55 to 100 wt. % cellulose acetate, based on the total weight of the film, e.g., from 55 to 99.5 wt. %, from 60 to 95 wt. %, from 65 to 90 wt. %, or from 70 to 85 wt. %.

In some embodiments, the cellulose acetate film does not contain shellac. In some embodiments, the cellulose acetate film does not contain rosin. In some embodiments, the cellulose acetate film does not contain shellac or rosin. Thus, the cellulose acetate films in certain embodiments are not shellac or rosin based.

In embodiments, plasticizer may be present from 0 to 40 wt. % based on the total weight of the film, e.g., from 1 to 35 wt. %, from 5 to 30 wt. %, or from 10 to 25 wt. %. The percentage of plasticizer may vary depending on the method by which the cellulose acetate film is formed. Generally, a greater weight percentage of plasticizer is used to form the film by melt extrusion as compared to solvent casting, e.g., from 15 to 40 wt. %, from 20 to 40 wt. %, or from 25 to 35 wt. % for melt extrusion and from 0.5 to 25 wt. %, e.g., from 1 to 25 wt. %, from 5 to 25 wt. %, or from 10 to 25 wt. % for solvent casting.

Various plasticizers may be used to reduce the glass transition temperature of cellulose acetate. Manufacturers of cellulose acetate may choose the type and amount of plasticizer (e.g., the ratio of plasticizer to cellulose acetate) based on a number of factors including the desired properties of a final composition and/or chosen for compatibility with other components of a final composition. For example, some types of plasticizers may be selected because they are biodegradable, allowing for the plasticized cellulose acetate to be eco-friendly. The amount of plasticizer may be chosen to: (i) reduce the glass transition temperature of the cellulose acetate (e.g., too low a plasticizer content may not reduce the glass transition temperature enough to allow for melt processing) and (ii) maintain desirable mechanical properties of the cellulose acetate (e.g., too high a plasticizer content may reduce the tensile strength and/or the thermal stability of a final composition).

Although a wide variety of plasticizers are known for plasticizing cellulose acetate, including those described in US Pub. No. 2015/0351311, a food grade plasticizer is preferred. For example, phthalates, phosphorus, and chlorinated plasticizers may be prohibited. As used herein, the term “food grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”) as of Apr. 30, 2017. Food grade plasticizers include triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In further embodiments, the plasticizer is triacetin. In still further aspects, the plasticizer does not contain a phthalate (is “phthalate-free”). In some embodiments, no plasticizer is used. In some embodiments, an amide wax is used. Yet, in some embodiments, neither plasticizer nor amide wax is used.

As discussed, the film also optionally comprises a processing aid. When included, the processing aid may be present in an amount from 0.05 to 10 wt. % based on the total weight of the film, e.g., from 0.1 to 5 wt. % , or from 0.5 to 2.5 wt. %. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. In some embodiments, the processing aid is silica. The average particle size of the processing aid may vary. In some aspects, the processing aid may have an average particle size from 0.01 to 50 μm, e.g., from 0.02 microns to 40 microns, from, from 0.05 microns to 30 microns. The particle size may be determined, for example, by sieve analysis. In some embodiments, no processing aid is used.

A releasing agent may also be included in order to improve releasability of the film, once formed, from a backing sheet or substrate. When included, the releasing agent may be present from 0.01 to 10 wt. % based on the total weight of the film, e.g., from 0.05 to 5 wt. %, from 0.05 to 1 wt. %, or from 0.05 to 0.5 wt. %. The releasing agent is generally included when the film is solvent cast, and is added to the dope. In some embodiments, the releasing agent is a fatty acid, such as stearic acid. In some embodiments, no releasing agent is used. In some embodiments, no plasticizer, processing aid, or releasing agent is used.

Some embodiments contain other additives. For example, embodiments can contain any of dyes, pigments, fragrances, repellants, indicators, surface agents, adhesion promoters, and/or gloss enhancers.

In embodiments, the coating layer may be either biodegradable, compostable (for example according to EN 13432), or both. For example, in an embodiment, the coating layer is compostable at a thickness of less than 125 μm, e.g., less than 100 μm, less than 80 μm, less than 50 μm, less than 30 μm.

In embodiments, the coating layer is water resistant, as determined by directly contacting the coating layer with liquid water. Substrate discoloration and/or breakthrough can be measured as a function of time. If the coated substrate does not show discoloration or breakthrough after 1 hour of exposure, the coating layer is considered to be water resistant. In embodiments, the coating layer is water resistant, as determined by direct contact with oil, for example corn oil. Substrate discoloration and/or breakthrough can be measured as a function of time. If the coated substrate does not show discoloration or breakthrough after 1 hour of exposure, the coating layer is considered to be oil resistant. In embodiments, the coating layer is both oil and water resistant.

In embodiments, the coating layer may maintain heat stability up to at least 150° C. In other embodiments, the coating layer may maintain heat stability up to at least 180° C. Heat stability means that the coating layer maintains integrity and function at the given temperature.

In embodiments, the film of the coating layer may have a glass transition temperature of at least 140° C. , e.g., at least 160° C., at least 180° C., at least 195° C., or at least 200° C., or from 140° C. to 200° C., or from 140° C. to 170° C., or from 140° C. to 150° C. In other embodiments, the film of the coating layer may be glossy or matte, as determined by visual inspection and by standard 20, 60 and 85° measurements. In some aspects, the film is glossy or high gloss. In other aspects, the film is matte. Without being bound by theory, it is believed that the surface area of the film is increased when the film is matte. In some embodiments, additional components may be added to the film. Such components include a matting agent, though such agent is not necessary to provide a matte film. In some aspects, the matte surface is imparted by the casting or extrusion process. In other aspects, an embossing roller may be used.

In embodiments, the coating layer may have a pencil hardness from 6B to 3H according to ASTM D3363 (2011). For example, the coating layer may have a pencil hardness of 6B, or of 5B, or of 4B, or of from 4B to 3H, or of 3B, or from 3B to 3H, or of 2B, or of from 2B to 2H, or of B, or of HB, or of from HB to 2H, or of from 6B to HB, or of F, or of from F to 3H, or of from 5B to F, or of H, or of from H to 3H, or of from 6B to H, or of 2H, or of from 5B to 2H, or of 3H.

The films and coatings of the present invention are can provide good hand feel and high visual appeal. In addition, the films and coatings can possess smoothness and not be cold to the touch.

The cellulose acetate film may be prepared by any film coating method known in the art. Examples of embodiments are is described below.

### Melt Extrusion

For melt extrusion, cellulose acetate and any optional components, such as a plasticizer, and/or a processing aid, are combined. The mixture may be formed by combining cellulose acetate, in flake or powder form, with the optional plasticizer and/or processing aid. In some embodiments, the optional plasticizer and/or processing aid may be combined with the cellulose acetate using a spray distribution system during the mixing step. In other embodiments, the optional plasticizer and/or processing aid may be added to the cellulose acetate during the mixing step, either continuously or intermittently. In some embodiments, the powder form of cellulose acetate is preferred while in other embodiments cellulose acetate flake may be used. Without being bound by theory, it is believed that the powder form may lead to a sheet with improved plasticization and uniformity as compared to the flake form.

After forming the mixture comprising cellulose acetate, plasticizer and optional processing aid, the mixture may be melt extruded in a small hole die to form filaments which are then sent to a pelletizer to form pellets. The melt extrusion may be performed at a temperature from 165 to 230° C., e.g., from 165 to 220° C. or from 165 to 210° C. The melt extruder may be a twin screw feeder with co-rotating screws, and may be operated at a screw speed from 100 to 500 rpm, e.g., from 150 to 450 rpm, or from 250 to 350 rpm. The pellets may then be extruded to form a film. In an embodiment, the film can also be extruded directly onto the substrate. The film may then be dried. In another embodiment, once dried, the film may then be crimped using a crimper.

### Solvent Based Preparations

Processes for preparing cellulose acetate films by using solvent, such as solvent casting, have been described in U.S. Pat. Nos. 2,232,012 and 3,528,833, the entireties of which are incorporated by reference herein. In general, a solvent process comprises preparing a mixture, also referred to as a dope, comprising cellulose acetate dissolved in a solvent, e.g., acetone and optionally plasticizer, processing aid, and/or releasing agent. The components of the mixture and the respective amounts determine the characteristics of the film, which is discussed herein.

As noted, the dope may be prepared by dissolving cellulose acetate in a solvent. In some embodiments, the solvent is acetone. In one embodiment, the solvent is selected from the group consisting of ethyl lactate, methyl ethyl ketone, and dichloromethane. In another embodiment, the solvent comprises acetone, ethyl acetate, methyl ethyl ketone, ethyl lactate, methyl amyl ketone, methyl propyl ketone and dimethyl carbonate, aprotic glycol ether, aprotic glycol ether ester, dimethyl sulfoxide (DMSO), n-methyl pyrrolidone (NMP), dimethylacetamide (DMAC), or combinations thereof. In embodiments, 2-propanol can be added to the solvent. To improve the solubility of cellulose acetate in the solvent, the cellulose acetate and the solvent may be continuously added to a first mixer. The mixture may then be sent to a second and/or third mixer to allow for full dissolution of the cellulose acetate in the solvent. The mixers may be continuous mixers that are used in series. It is understood that in some embodiments, one mixer may be sufficient to achieve cellulose acetate dissolution. In other embodiments, two, three, or more mixers (e.g., four mixers, five mixers, or greater than five mixers) may be used in series or in parallel. In yet other embodiments, the cellulose acetate, solvent, and other additives may be combined in one or more blenders, without the use of any mixers.

The dope may then be dried to evaporate the solvent to prepare a film. The dope can be cast directly on the substrate to form the coating. The inclusion of a releasing agent can improve the release of the film from the casting band. The film may dried and crimped as described above.

Thus, in one embodiment, a method of forming a coated substrate is to a) combine cellulose acetate with a solvent to form a dope or coating formulation, b) coating at least one surface of the substrate with the coating formulation, c) processing the coating formulation on the substrate to form the coated substrate.

In embodiments, the dope can have a solids concentration of 0 to 80%, e.g., 0 to 60%, 0 to 50%, 0 to 40%, 0.1 to 80%, 0.1 to 50%, 0.1 to 40%, 1 to 30%, 1 to 20%, 5 to 20%, 5 to 15%, or 15%.

In embodiments, the dope can have a viscosity from 25 to 10,000 centipoise (“cps”) (mPa·s), e.g., 25 to 8,000 cps, 30 to 5,000 cps, 50 to 1,000 cps, or 100 to 500 cps. In one embodiment, the dope can have a solids concentration from 0.1 to 80% and a viscosity from 50 to 10,000 cps.

In addition to casting as described above, the mixed cellulose acetate dissolved in solvent (dope) can be applied as a coating using a number of methods. For example, the dope can be applied as a brush coating where the dope is applied on the surface of the substrate by means of brushes. In addition, the dope can be applied to the surface of the substrate as a spray coating by means of a spraying device. Other methods include roll coating and gravure coating where the dope is applied to the substrate using rollers (an engraved roller in the case of gravure coating). Another process that can be used is curtain coating, where an uninterrupted curtain of dope falls through from a gap onto the surface of the substrate. The speed of the substrate (for example, on a conveyor belt) is controlled to provide an even coat of the dope, if desired. Similarly, the coating can be formed by using a dip coating method. In this method the substrate is immersed in a tank of the dope and continuously moved through at a constant speed. A thin layer of the dope deposits on the substrate when it is withdrawn from the tank of dope. The thickness of the coating can be adjusted based on the speed of the substrate. In addition, if desired for the final product, the thickness can be varied across the substrate. For any of the above methods, the film can be dried to remove the solvent.

### Substrate

In embodiments, the compositions of the present invention can be used in food related applications, such as to package, support, or contain food items. In other embodiments, the compositions of the present invention can be used in non-food related applications. In embodiments, the compositions of the present invention can be used where biodegradability or compostability is desired.

Substrates used in the invention can be chosen from a variety of materials. In embodiments, the substrate can be cardboard, paper, plastic, fabric, paperboard, or combinations thereof. In embodiments, the substrate can be made of Styrofoam. In embodiments, the substrate can be biodegradable. In embodiments, the substrate can be compostable, for example Home and Industrial compostable. In embodiments, the substrate can be made of recycled material(s). For example, the substrate can be made of recycled cardboard, recycled paper, recycled plastic, recycled paperboard, or combinations thereof. In one embodiment, the substrate can be made of recycled cardboard. However, in some embodiments, the substrate is neither compostable nor biodegradable.

Embodiments of the present invention can be used in direct or indirect food contact packaging applications requiring liquid barrier protection. In embodiments, the coated substrate can be used in food packaging or food containers. For example, in one embodiment, the coated substrate can be used in food trays. In embodiments, the coated substrate can be used in drink cups, fast food service containers, drink holders or coasters. In other embodiments, the coated substrates can be used in non-food applications. For example, the coated substrate can be used in posters and billboards, envelopes, or notebook covers.

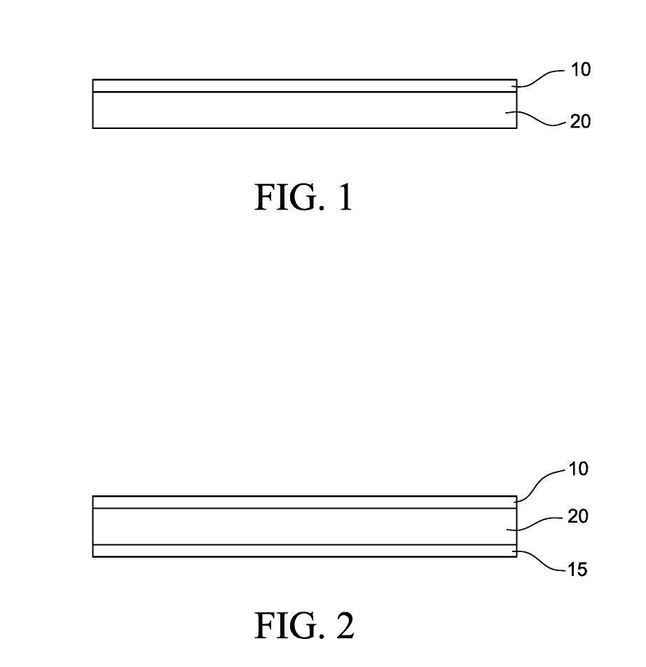

The substrate can have one or more surfaces. The coating can be applied to at least one of the one or more surfaces. For example, the coating can be applied to a top surface or a bottom surface of the substrate. FIG. 1 shows an embodiment where a film (10) applied to the top surface of the substrate (20) to provide the coating. In embodiments, the coating can be applied to multiple surfaces. For example, the coating can be applied to a top and/or a bottom surface of the substrate. In some embodiments, different coatings can be applied to different surface of the substrate. For example, a cellulose acetate film comprising plasticizer may be applied to one surface of the substrate, while another cellulose acetate film not containing plasticizer may be applied to another surface of the substrate.

FIG. 2 shows an embodiment where a first film (10) is applied to the top surface of the substrate and a second film (15) applied to the bottom surface of the substrate (20). The first film (10) can be the same or different than the second film (15), depending on the embodiment.

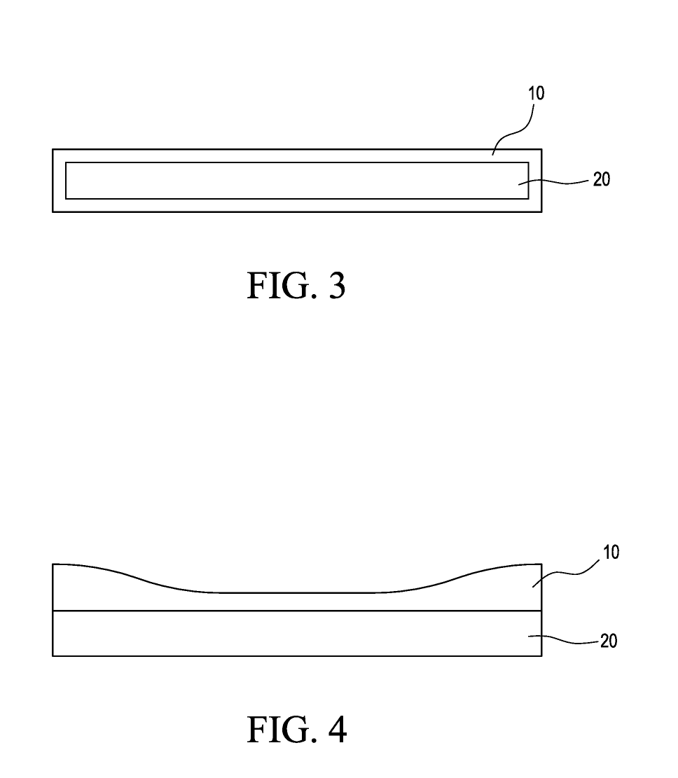

FIG. 3 shows an embodiment where a film coating (10) is applied to the top and bottom surfaces (and edges) of the substrate in a single continuous coating.

In some embodiments, the coating can be of different thicknesses. For example, the coating can be thicker in some sections than others. FIG. 4 shows an embodiment where the film coating (10) is thicker near the edges of the substrate than in the middle, creating a sloped surface, which may, for example, keep fluids in the center of the substrate. In some embodiments, multiple layers of film can be layered to provide the coating. The layers of film can be the same or different formulations.

In some embodiments, the coating can be at least 10% thicker at the edges of the substrate than at the middle of the substrate, e.g., 10% thicker at the edges of the substrate than at the middle of the substrate, at least 20% thicker at the edges of the substrate than at the middle of the substrate, at least 30% thicker at the edges of the substrate than at the middle of the substrate, at least 50% thicker at the edges of the substrate than at the middle of the substrate, at least 80% thicker at the edges of the substrate than at the middle of the substrate, at least 100% thicker at the edges of the substrate than at the middle of the substrate, at least 200% thicker at the edges of the substrate than at the middle of the substrate, or between 10% and 200% thicker at the edges of the substrate than at the middle of the substrate.

In some embodiments, the coating can be applied to achieve at least a 2% gradient from its thinnest point to its thickest point, for example, at least a 3% gradient from its thinnest point to its thickest point, at least a 5% gradient from its thinnest point to its thickest point, at least an 8% gradient from its thinnest point to its thickest point, at least a 10% gradient from its thinnest point to its thickest point, at least a 15% gradient from its thinnest point to its thickest point, at least a 20% gradient from its thinnest point to its thickest point, at least a 30% gradient from its thinnest point to its thickest point, or from a 3% gradient to a 25% gradient from its thinnest point to its thickest point.

In certain embodiments, the coating layer does not penetrate into the substrate. In other embodiments, the coating layer does penetrate into the substrate. For example, the coating layer can penetrate into the substrate to a depth of 0.5 μm to 800 μm, e.g., 1 μm to 500 μm, 10 μm to 500 μm, 100 μm to 500 μm, or 100 μm to 300 μm.

The present invention will be better understood in view of the following non-limiting example.

### EXAMPLE

### Example 1

A solution of cellulose acetate in acetone with a 15% solids concentration was applied to a substrate of recycled cardboard and dried to form food trays. The color was observed as white to slight yellow. The coated food trays were exposed to direct contact with corn oil. Substrate discoloration and/or breakthrough were measured as a function of time. The coated food trays did not exhibit discoloration or breakthrough after 7 weeks of constant exposure. The food trays were also exposed to direct contact with liquid water. The food trays did not show any discoloration or breakthrough after 1 week of constant exposure. The coated food trays also had the following performance: Heat stability of up to 150° C. Tg of the coating of 195° C.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention. All US patents cited herein are incorporated by reference in their entirety.

We claim:

1. A coated substrate, comprising:
(a) a substrate having one or more surfaces; and
(b) a coating layer disposed on at least one of the one or more surfaces, the coating layer comprising a cellulose acetate film having a glass transition temperature (Tg) of at least 140° C.

2. The substrate of claim 1, wherein the coating layer has a thickness from 0.1 to 500 microns.

3. The substrate of claim 1, wherein the coating layer is compostable.

4. The substrate of claim 1, wherein the substrate is compostable.

5. The substrate of claim 1, wherein the coating layer and the substrate are biodegradable.

6. The substrate of claim 1, wherein the substrate comprises cardboard, paper, plastic, fabric, paperboard, or a combination thereof.

7. The substrate of claim 1, wherein the coating layer is oil and water resistant.

8. The substrate of claim 1, wherein the coating layer has a pencil hardness from 6B to 3H.

9. The substrate of claim 1, wherein the substrate is coated with the coating layer on at least a top and bottom surface of the substrate.

10. The substrate of claim 1, wherein the coating layer has heat stability up to at least 150° C.

11. The substrate of claim 1, wherein the coating layer further comprises plasticizer.

12. A method of forming a coated substrate, the method comprising:
a) combining cellulose acetate with a solvent to form a coating formulation;
b) coating at least one surface of the substrate with the coating formulation; and
c) fixing the coating formulation on the substrate to form a coated substrate.

13. The method of claim 12, wherein the coating formulation has a solids concentration from 0.1 to 80%.

14. The method of claim 12, wherein the coating step comprises coating the coating formulation on the substrate in a thickness from 0.1 to 500 microns.

15. The method of claim 12, wherein the coating formulation has a viscosity from 25 to 10000 cps.

16. The method of claim 12, wherein the solvent comprises acetone, n-butyl acetate, ethyl acetate, methyl ethyl ketone, ethyl lactate, methyl amyl ketone, methyl propyl ketone and dimethyl carbonate, aprotic glycol ether, aprotic glycol ether ester, dimethyl sulfoxide (DMSO), n-methyl pyrrolidone (NMP), dimethylacetamide (DMAC), and combinations thereof.

17. The method of claim 12, wherein the coating formulation is coated on the surface of the substrate using spray coating or brushing.

18. The method of claim 12, wherein the coating layer has heat stability up to at least 150° C.

19. The method of claim 12, wherein the coating layer is oil and water resistant.

20. A cellulose acetate coating formulation, the formulation comprising cellulose acetate and a solvent, wherein the formulation has a solids content from 0.1 to 80% and a viscosity from 50 to 10000 cps.
